(19) United States
(12) Patent Application Publication
(10) Pub. No.: US 2020/0125998 A1
(43) Pub. Date: Apr. 23, 2020

(54) METHOD FOR ACHIEVING COMPLIANCE WITH GOVERNANCE STANDARDS

(71) Applicant: Perry L. Johnston Registrars of Texas, L.P., Dallas, TX (US)

(72) Inventor: Perry L. Johnson, Bloomfield Hills, MI (US)

(21) Appl. No.: 16/522,565

(22) Filed: Jul. 25, 2019

Related U.S. Application Data
(63) Continuation of application No. 12/376,509, filed on Feb. 5, 2009, now abandoned.
(60) Provisional application No. 60/835,978, filed on Aug. 7, 2006.

(51) Int. Cl. G06Q 10/00; G06Q 10/10; G06Q 10/06; G06Q 30/00

(52) U.S. Cl. CPC G06Q 10/00; G06Q 30/018; G06Q 10/063; G06Q 10/103

(57) ABSTRACT

A method for evaluating and achieving compliance with industrial or governmental standards that includes obtaining client information to identify a client's business operations procedures and a client's needs, reviewing applicable industrial or governmental standard particulars, evaluating the client's business operations in view of industrial or governmental standard particulars, presenting a deliverable component to the client identifying revisions to client business practices to conform to the industrial or governmental standards and implementing a risk assessment policy for the client based on the findings of the deliverable component. The method may be tracked with scheduling and project software.

### CROSS-REFERENCE TO RELATED APPLICATION

This application claims the benefit of U.S. provisional application Ser. No. 60/835,978 filed Aug. 7, 2006.

### BACKGROUND OF THE INVENTION

### 1. Field of the Invention

The present invention relates to a methodology that enables a business entity to achieve compliance with governance standards.

### 2. Background Art

The fierce competition of the 1980s taught American business and industry an unforgettable lesson: Firms that do not provide quality products and services do not thrive, and may not survive. In the 1990s, and on into the 21st century, the definition of quality broadened beyond the caliber of the product or service itself. This extension includes every aspect of providing a product or service, from selling through delivery, to billing and after-sale service.

When choosing suppliers for materials, parts or services, customers at every level, whether industrial, wholesale or retail, need and want a guarantee that they will receive all-around quality. That demand can be met through a comprehensive approach to quality management. As such various national and international organizations have developed series of standards which apply to quality, environmental, occupational health and safety, and other management systems. For example, international and national standards such as ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001, have been developed to provide a measure and method for quality management in various industrial and commercial concerns. A standards registrar provides a third-party certification that a particular organization conforms to one or more of such national and/or international standards. As such, standards registrars typically must be recognized or accredited by various national and/or international governmental or quasi-governmental agencies as also possessing a level of competence that the registrar's certification may be relied upon. Examples of such governmental or quasi-governmental agencies include the Registrar Accreditation Board (RAB) in the United States, the RvA of the Netherlands, the IJKAS of Great Britain, TGA of Germany, JAB of Japan, and INMETRO of Brazil. As more and more countries and industries recognize the importance of quality standards, the need for certification and registration continues to increase with an associated increase of standards registrars and national and international accrediting bodies.

The word “quality” itself is the cause of much confusion. Quality is defined by the international standards organization (ISO) in ISO 9000:2000, 3.1.1 as the “degree to which a set of inherent characteristics fulfills requirements” and by ISO 8402:1994, 2.1 as the “totality of characteristics of an entity that bear on its ability to satisfy stated and implied needs.” Achieving a satisfactory level of quality involves all activities having an influence on quality.

For the purposes of attaining customer satisfaction, quality means fitness for purpose or fitness of use. Simply stated, it is the ability to meet a given need. Whether the quality of a product or a service is appropriate, depends on the need(s) it is meant to fulfill. For example, the fitting of bathroom floor tiles for the restrooms in a local shopping mall would be determined by quite different standards from tiles meant for the bathroom of a private home. Likewise, a cleaning service used by a laboratory will need to meet different standards from one used by an insurance office. As such, before quality can be determined or judged, it is necessary to understand the measure, which is generally based on the customer's requirements. These requirements are not limited simply to the product or service, however. They encompass all other aspects of the transaction, including price, delivery and its timing, and after-sale service.

The history of quality can be traced as far back as the days of the caveman. A self-sufficient caveman was both a supplier and user. In order to be both, he had to know exactly what was needed, fulfilling the customer requirement, and then became a supplier by creating or manufacturing that item. This common-sense methodology has been passed down through the generations of mankind and is still in practice today. The same concepts can be applied to internal suppliers and customers. Internally, quality also means timely delivery of the product or service required to meet a defined need. The correct and properly made rough castings, for example, must be delivered in the right number to the matching area when they are needed. The company's mail must be correctly sorted and delivered according to schedule, etc.

The chief goal of many businesses is to make a profit for the owner, whether an individual, a partnership or several thousand stockholders, through selling goods or services. Over time, businesses have employed many different strategies to improve their prospects of making a profit, Quality management provides important benefits for customers, but it is even more valuable to the firm. With quality management, companies can improve revenues and cut costs. Superior quality helps companies compete more successfully for new customers. It is also critical in retaining current customers. It is well known that it costs much more—estimates range from 5 to 20 times more, depending on the industry—to attract a new customer than to retain a present one. At the same time, internal efficiency improves, providing additional cost savings. Quality management prevents inefficiencies and the related labor, material, machine, and inventory costs. It also helps a company avoid the costs of delayed payments, reshipment, and repeated service calls. Without question, the quality imperative is healthy for business and industry, consumers and the economy as a whole.

Quality expert Dr. W. Edwards Deming, who introduced quality concepts and processes to the Japanese in 1950 with results that have shaken business and industry worldwide, describes the results of quality achievement as a chain reaction: Improve Quality—Improve Productivity—Decrease Costs—Decrease Prices—Increase Market Share—Stay in Business—Provide More Jobs—Return of Investment.

Fear, confusion, or excessive optimism are sometimes generated by the prospect of a quality management system or audit. Managers envision loss of decision-making authority, downtime due to excruciatingly thorough inspections, loss of productivity, mountains of paperwork, and huge costs. Workers often fear punitive actions. Conversely, both managers and workers sometimes expect quality management to solve all the company's problems. But quality management is not a cure-all. It can resolve some problems, but it offers no miracle cure. It will do none of the aforementioned things.

Quality auditors are generally not responsible for technical decisions, and quality management auditing is not inspection. While reports are made, paperwork for managers and workers is moderate to minimal. The cost of quality management is relatively small and is normally more than offset by cost savings. Businesses today are increasingly embracing quality management as a major profit-making strategy. The fact that quality management has become such a prominent strategy in a relatively short time testifies to its extraordinary effectiveness.

The United States Congress passed to legislation the Sarbanes-Oxley Act of 2002. The Sarbanes-Oxley Act (“the Act”) established new or enhanced standards for corporate accountability in the United States, Historically, individual states generally had exclusive jurisdiction over corporate governance matters. The Act attempts to provide fundamental mechanisms to prevent the misdeeds that led to investor losses early this millennium. These mechanisms are intended as best practices to be observed by domestic and foreign business entities listing for trade in U.S. markets. Many of the provisions are not outright requirements, but are requirements on corporations to disclose aspects and then let the market decide what importance to put on that disclosure.

As the number of worldwide business entities transacting business in the United States come to grips with the requirements of the Act, a need for accrediting bodies increases in response to the recognition by business of the importance of compliance with these corporate governance and thereby, quality management standards. There exists a need for a method for evaluating the core business practices of entities for compliance with these governance standards. There also exists a need for a process that evaluates each business area of a client to establish that all units are in compliance with governance standards.

### BRIEF DESCRIPTION OF THE DRAWINGS

FIG. 1 is a block diagram illustrating one aspect of a process for evaluation of governance standards in accordance with the present invention;

FIG. 2 is a block diagram illustrating the process for evaluating governance and quality management standards according to one aspect of the present invention; and

FIG. 3 is a block diagram illustrating the evaluation and consulting tools for use in connection with the process in accordance with the present invention.

### DETAILED DESCRIPTION OF THE PREFERRED EMBODIMENT(S)

### The Meaning of Quality Management

The basis of quality management is to satisfy a given need, according to the customer's requirements. That means the basic concern is to make sure that every element of a company, whether it be processes, procedures, systems, or personnel, is geared to furnish: the right product or service, delivery of the product or service to the right customer, delivery at the right time to the right location, delivery of a product or service that meets requirements, delivery of a product or service that satisfies the customer, provision for the appropriate after-sale service, information needed to answer quality-related questions in the context of producer liability, and delivery of all of the above at the negotiated price.

Quality management is vital to all companies, especially in the area of compliance with governance standards. The quality management system any company establishes depends upon its current and targeted markets and their quality requirements. Companies should use applicable requirements when they implement their quality management system.

For any company, quality improvement begins with four basic action steps. The first step is adopting a definition of quality or compliance. This includes conforming to requirements, especially those of the customers. The second step is setting up a system to fulfill this defined quality. This is a prevention system that identifies the chances for mistakes and eliminates them. The third step is establishing performance standards. These must be error-free. Defects and errors are neither inevitable nor acceptable. The fourth step is measuring costs. This means calculating the cost of quality by comparing the cost of nonconformities, incurred from not doing it right the first time, such as scrap, rework and lost customers, to the price of conformity, incurred to ensure things are done right the first time.

The issue of detection versus prevention is the difference between quality control and the quality assurance approach of a quality management or compliance system. The former seeks to detect, while the latter tries to prevent nonconformities. Systems with a focus on quality assurance catch nonconformities as they arise in a process. Ideally, they are easier and less costly to remedy at this point. On the other hand, systems with a focus on quality control will let nonconformities go until the end of the process. Once these problems are detected, they are likely much more difficult and costly to fix.

### Quality Standards

Quality standards of various types have been in use for centuries. In medieval times, as craftsmen began to band together to form guilds, they created their own standards by which expertise in their various skills was measured. On the user side, quality standards originated out of military necessity. An English king appointed an officer to oversee the production of naval ships nearly a thousand years ago, At about the same time, another official was put in charge of supervising the quality and effectiveness of land-based weaponry and engineering. In recent times, quality standards have continued to be driven by military necessity. In 1912, the British government created an office to ensure the quality of military aircraft. In the United States, quality standards became paramount during and after World War II with the establishment of the MIL STD series of standards. These continued for decades to he the major quality standards imposed upon suppliers to the U.S. Department of Defense.

Quality standards of a non-military nature have matured in more recent years. In the late 1970s, as quality became imperative for many multinational, organizations, it became clear that quality of output was directly related to quality of input. Therefore, major firms which relied heavily on suppliers for subassemblies and components began to create their own proprietary quality standards and mandated them to their supply base.

In Europe, the approach to quality standards has followed a somewhat different course. There, the lead on standards has been taken by government rather than by the private sector. Great Britain, for example, codified BS 5750, a set of national quality system standards, in 1979. This standard was made a requirement for suppliers to the government, especially the military, and the full weight and force of the government were placed upon promoting BS 5750 throughout the private sector. The government actively encouraged firms to register. It created an agency which accredited registration bodies and sanctioned another to authorize trainers and courses. The government also publicized BS 5750 to increase awareness and acceptance of the standard among the population.

The European Union (EU) also adopted a quality systems standard, EN-29000, which resembled BS 5750 in many respects. Both EN-29000 and BS 5750 were models for ISO 9000, which was adopted in 1987, and revised in 1994 and 2000. ISO 9000 is used throughout the EU. In ensuing years, the three standards have been harmonized to the point that they are synonymous.

The International Organization for Standardization (ISO), formed in 1946, is a consortium of 132 national standards bodies. The member body representing the United. States is the American. National Standards Institute (ANSI). Based in Geneva, Switzerland, the International Organization for Standardization created the ISO 9000 quality management systems standard series, which includes ISO 9001:2000, ISO 9001/9002:1994 and Q9000, the American version. ISO 9000 was developed to simplify the international exchange of goods and services through a common set of universally accepted quality standards. ISO 9000, a descendant of BS 5750 and the U.S. military standard MIL-Q-9858A, is a series of standards on quality assurance and quality management. The standards are not specific to products or services, but apply to the processes which create them. The standards were purposely designed to be generic so that they can be used by any industry anywhere in the world. The series specifies goals, objectives and philosophies, but not procedures.

Since its creation, ISO 9000 has served as the building block for many other standards. Its quality management systems derivatives include the U.S. automotive manufacturers' QS-9000, the international automotive standard ISO/TS 16949, the German automotive standard VDA 6.1, the international telecommunications standard TL 9000, the international aerospace standard AS9100, the international medical devices standard ISO 13485, and two QS-9000 derivatives: the Tooling and Equipment (TE) Supplement and the Semiconductor Supplement.

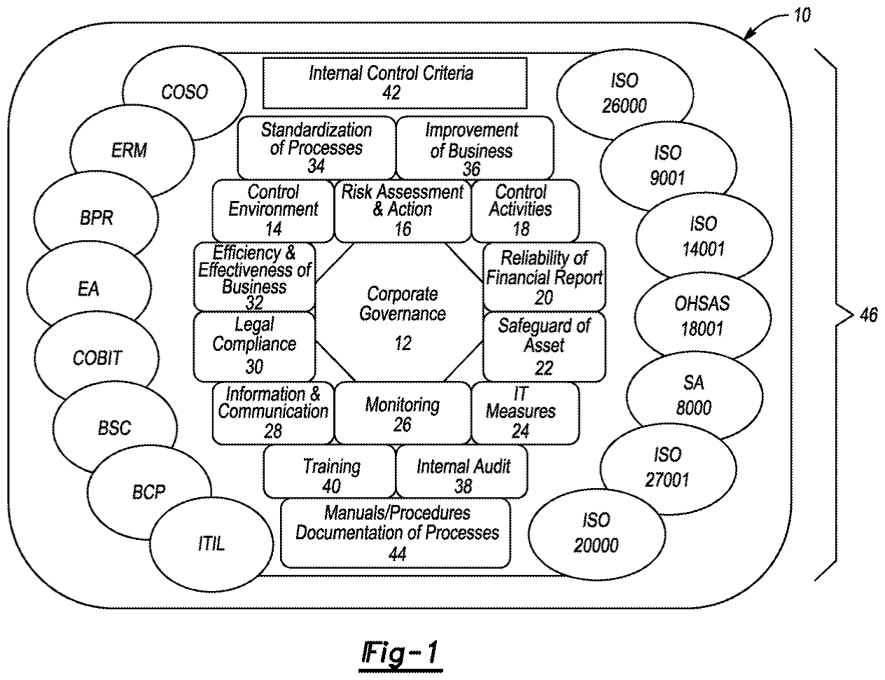

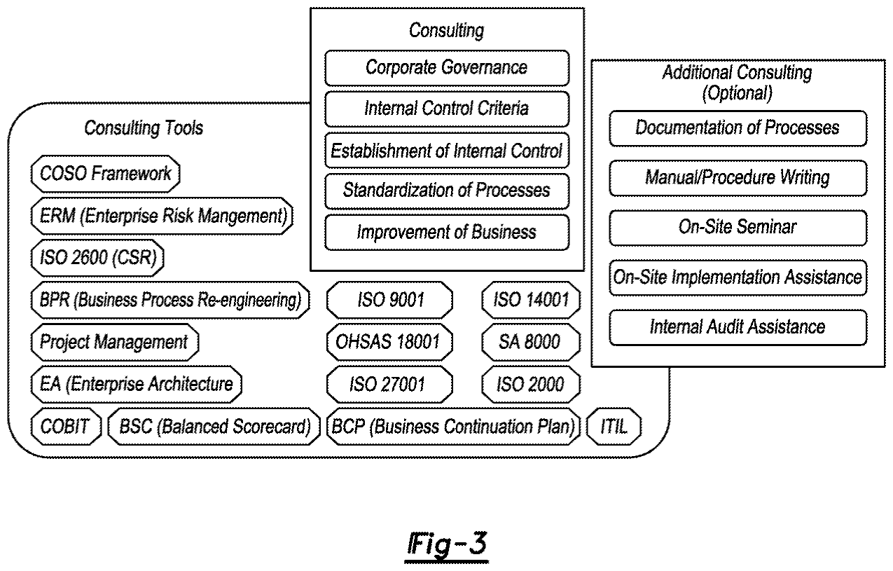

Other international and national standards which are similarly structured to ISO 9000 include the environmental management systems standard ISO 14001, the calibration and testing laboratories quality management systems and technical competence standard ISO/IEC 17025, the occupational health and safety management systems standard OHSAS 18001, and the U.S. Food and Drug Administration (FDA) Current Good. Manufacturing Practices (CGMP) for medical devices. These standards are utilized as consulting tools in the process in accordance with the present invention and illustrated in FIGS. 1 and 3.

### Quality Plan

The quality plan (ISO 9001:2000, Element 5.4; ISO 9001/9002:1994, Element 4.2.3) is often a contractual document in which the customer specifies that the supplier take certain quality measures in producing the contracted output. The contents of a quality plan, also known as a control plan, may include inspection plans, design milestones, and critical and/or major subcontractors and requirements. Upon customer approval, the quality plan or control plan becomes an integral part of the contract. When creating a quality plan or control plan, the following activities should be considered, if appropriate: identify and acquire the controls, processes, equipment, fixtures, resources and skills needed to meet quality objectives; verify whether designs, processes, procedures for installation, servicing, and inspection and test activities, and any applicable documentation are compatible with the output (product); update methods for quality control and inspection and testing techniques; when necessary, identify any extraordinary measurement requirements; identify verification activities suitable for both the product and the production process; understand and document standards of acceptability to eliminate any subjectivity; and maintain the required quality records to demonstrate the implementation and effectiveness of the quality management system.

The quality plan or control plan may consist of quality documentation, such as procedures and work instructions, specifying general activities and tasks that must be completed. Documentation serves as the foundation of the quality management system. It is essential to ISO 9000, because it provides objective/audit evidence for the system's status. Documentation also plays a critical role for the quality management system auditor, because it is an invaluable reference resource. It explains the company's policies, defines authority, and establishes operational procedures and work instructions to help employees fulfill their job responsibilities.

When it comes to the quality management system, the documentation is structured like a pyramid. This documentation is divided into four tiers as shown in Table 1.

TABLE 1

| Tier | Documentation Example |
|---|---|
| Tier 1 | Quality Policy and Manual(s) |
| Tier 2 | Procedures |
| Tier 3 | Work Instructions |
| Tier 4 | Quality Records |

### The Quality Manual (Tier 1)

The quality manual is considered a top-level document, occupying the top of the quality management system documentation pyramid. It states the company's quality policy and describes the organization's quality management system. Among all of the elements that comprise the ISO 9000 quality management system, none is more important than the quality manual. This controlled circulation document serves a multitude of essential purposes. It is a living, working document meant to be actively used. The quality manual has numerous functions which may include aiding in creating and implementing a quality management system, describing the objectives and structure of the quality management system, demonstrating management's commitment to the system, serving as a cross-reference between the quality management system and ISO 9001:2000, serving as a cross-reference to facility procedures, and serving as a quality management system reference document for auditors and other designated parties, such as registrars, investors and customers, for example. In addition to covering the appropriate sections of ISO 9000, the quality manual can, and usually does, contain a brief statement of the company's commitment to quality, a brief policy statement addressing the company's quality image and reputation, a short company profile aimed at customers and suppliers, a facility mission statement on how the company plans to pursue its quality objectives, a distribution list (controlled circulation), a reference list of facility procedures, and a statement of authority and responsibility.

### Procedures (Tier 2)

Procedures are the next level of documentation. They are referred to as Tier 2 documents. A procedure gives information on what activities are conducted in an organization, how they are performed, and who has direct responsibility for them. While the quality manual is a company-wide document, procedures are an extension of the quality manual aimed at different departments. They are activity-based, describing the methods and practices that are used to carry out various quality management system activities that cross functional or organizational lines.

Procedures do not need to be lengthy and redundant. They should be simply written and easy to understand. The ISO 9001:2000 and ISO 900119001:1994 standards both state that a facility need only have documented procedures and work instructions. An effective procedure that clearly defines responsibilities will reduce the amount of training needed by new employees. They should be able to perform the task simply by following the procedure.

### Work Instructions (Tier 3)

Work instructions fall under the next level of quality documentation, Tier 3. They are directed at the doers of an organization, including the operators carrying out activities in support of the quality management system, and production line workers. While procedures describe an activity, work instructions explain how to do the various tasks specified within a procedure. Work instructions are generally completed by an individual or department. They describe the steps to follow, equipment and resources required for a job, precautionary measures to be taken and other required matters. Work instructions contain specifics, and should be as detailed as necessary to assure clarity and compliance. Since work instructions are “how to” documents, they are likely to change more frequently than the quality manual.

### Quality Records (Tier 4)

Quality records are documents that furnish objective/audit evidence that a quality requirement has been fulfilled or demonstrate that the quality management system is operating effectively. These records can be written or stored on any data medium. Records should be kept in a protected place to prevent loss, damage and deterioration. The quality management system should define how long records are to be kept and the disposal method.

### Quality Audits

In today's customer-oriented global business environment, improvement and governance measures must be implemented not only to maintain a competitive edge, but also to comply with Federal law and retain investor confidence, Nearly every activity in an organization could benefit from improvement measures, including the processes that monitor the quality of products and services. One effective tool companies can use in their mission of continual improvement is the quality assurance (QA) audit. Since the dawn of the quality age, the term quality audit has come to mean different things to different people.

### Objectives of Auditing

Audits have received a bad reputation over the years. The process is often seen by employees and management alike as fuel for retribution or discipline, rather than as an aid which supports error reduction and elimination, compliance, verification, and communication. Audits contribute to achieving many positive objectives. Most importantly, audits are essential to the process of verifying the performance of a facility's quality management system such that the practice conforms to the applicable standard.

### The Audit Team

The lead auditor is placed in overall charge of the audit team, which consists of one or more auditors. The audit team should, depending upon circumstances, include experts with specialized backgrounds. The team may include auditor trainees or observers, with the consent of the client, the auditee, and the lead auditor.

### Nonconformities

According to ISO 9000:2000, 3.6.2 and ISO 8402:1994, 2.10, a nonconformity is nonfulfillment of a (specified) requirement. Nonconformities are classified as either major or minor. Nonconformities may be written as a result of any type of quality audit. When an auditor identifies a nonconformity, he or she must confirm it through objective/audit evidence. Objective/audit evidence is information, such as records or statements of fact about the quality management system, acquired through observation, measurement, test or other means, that can be proven true or are factual in nature.

The ISO 9000:2000 standard, section 3.8.1, defines objective evidence as: “Data supporting the existence or verity of something.” ISO 8402:1994, 2.19, defines objective evidence as: “Information, which can be proved true, based on facts obtained through observation, measurement, test or other means.” ISO 9000:2000, 3.9.4, defines audit evidence as: “Records, statements of fact or other information which are relevant to the audit criteria and verifiable.” ISO 10011-1:1990, 3.7, defines objective evidence as: “Qualitative or quantitative information, records or statements of fact, pertaining to the quality of an item or service or to the existence and implementation of a quality system element, that are based on observation, measurement, or test, and that can he verified.”

While the finding of a nonconformity often triggers alarm, this should not happen. Nonconformities are not necessarily bad. They identify weaknesses that may be developed into strengths and point out areas where improvements can be made, leading to continual improvement. Nonconformity causes vary. Major nonconformities can be caused by the lack of a procedure or an inconsistency in implementing the quality system. Major nonconformities can greatly affect product or service quality, put the facility or employees at risk of losing customers, jeopardize industry or government certification, and/or cause great harm to other operations in the company. Some examples of major nonconformities include: no documented procedures for contract or design reviews, internal audit reports of remaining system deficiencies with no evidence of follow-up, a considerable number of inspections, measuring and test equipment without current calibration, and drawing or planning changes carried out informally and unapproved in a number of instances.

Other major nonconformities include a single deficiency in the quality management system, product or service, a lack of quality management system documentation to satisfy requirements, quality management system documentation not being implemented consistently, or a series of minor nonconformities indicating an overall quality management system weakness in an area or activity that collectively have significance. Registration cannot be obtained until corrective action has been taken on all major nonconformities.

The lesser degree of a deficiency, minor nonconformities, are those which do not directly affect product or service quality, or are deemed easily rectified. Some examples of minor nonconformities include: isolated examples of drawings marked up with unauthorized design or tolerance changes, isolated examples of instrumentation out of calibration date, evidence of corrective action still outstanding on internal audit nonconformity reports, isolated examples of deficient record keeping on contract or design reviews, and insufficient documentation of training experience gained by employees.

Another example of a minor nonconformity includes situations where a defined quality management system, documented procedures, and work instructions exist, there is an acceptable level of implementation overall, but there are minor discrepancies or lapses in following the quality management system requirements or documentation.

There are two other variations of nonconformities which can also occur: the “vital few” and the “trivial many.” The “vital few” nonconformities can greatly affect quality, though few in number. They usually represent detriments to safety or economics. These may also be chronic problems detected in earlier audits or specifically mentioned by auditees as ongoing concerns. The “trivial many” nonconformities are often minor and occur in great numbers, typically three or more minor nonconformities against one requirement. These can reflect systemic errors and affect quality due to high volume. When applied against a single requirement, the Trivial Many can constitute a major nonconformity. Nonconformities are cited when the process does not conform to the quality manual or ISO 9000.

Nonconformities typically occur when procedures have not been properly implemented. This causes the process to be ineffective. Observations are another audit classification. An observation is a weakness in existing conditions that, in the auditor's judgment, warrants clarification or investigation to improve the overall status and effectiveness of the quality management system being audited.

As an example, during the course of the audit, objective/audit evidence was inadequate to clearly determine if the quality management system activity being audited was conforming or nonconforming to specified requirements. Observations may signal the potential for future nonconformities, but do not require a response by the auditee.

### Recording Nonconformities

Once a nonconformity is found, it may be recorded on a nonconformity report (NCR). The auditor should make sure that the nonconformity report is accurate, concise and easy to read. In the NCR, auditors must list the audit number or identification, audit date, the area under review, the standard referenced, a report of the nonconformity, based on factual statements, and identification of the responsible auditor and the auditee representative. Upon completion, the NCR has to be signed by both the auditor and the auditee representative. This confirms that the auditee is aware of the nonconformity and agrees that corrective action is needed. It is critical that clear, ongoing communication exists between the audit team and the auditee to ensure that no surprises occur at the closing meeting. After the nonconformance has been acknowledged, the Lead Auditor and the auditee need to agree on a date by which corrective action must be completed, as well as any follow-up measures.

### Corrective Action Follow-Up

After the quality management system audit has been completed and the final audit report has been submitted, decisions on corrective and preventive actions need to be made by the auditee. The auditors are responsible for identifying nonconformities and documenting them with observations backed up by objective/audit evidence. They should also obtain acknowledgment of the nonconformity from the auditee, during the audit itself or at the closing meeting. Auditors may make recommendations, if requested, but only the auditee can create and implement corrective actions.

It is incumbent upon the audit process, whether first-party (internal), second-party or third-party, to follow up on past nonconformities by evaluating the creation, implementation and effectiveness of corrective actions. Only when corrective actions have been implemented and objectively proven to be effective can a nonconformity be considered eliminated. Actions to eliminate the cause of nonconformities can come from market feedback, customer complaints, management reviews, nonconformity reports, and internal and external audits.

### Corrective Action

There are several forms of corrective and preventive actions that may be used to address nonconformities. One is a quick fix correction or a short-term corrective action, sometimes implemented on the spot to mitigate further damage until permanent long-term preventive actions can be implemented. Long-term preventive actions are aimed at eliminating the causes of nonconformities and usually involve changes in procedures and systems. They often take some time to implement because complex process changes are involved.

To facilitate adequate follow up, auditees should carefully document the process of implementing and monitoring corrective and preventive actions. Affected employees should be briefed and, if necessary, adequately trained in corrective action measures, especially if they are responsible for monitoring effectiveness. A written statement of corrective action implementation from the responsible area should be secured. The responsible area management should be contacted to determine why the actions were not taken if a written statement is not received by a predetermined deadline. The auditee should document the corrective action process by completing the second part of the nonconformity report form. This includes a description of the corrective action developed by the auditee, preventive action taken to keep the nonconformity from recurring, and auditee signature in both areas.

### Follow-Up

Audits are cyclical activities. Prior audit results are used as reference, and often guidance, when developing the scope and plan of subsequent audits. The findings of an initial audit may also trigger another full-scale or mini-audit to confirm that corrective actions to address specific nonconformities have been implemented. To be effective, the initial audit plan might include the requirements and process for conducting follow-up activities to address nonconformities. Findings that might warrant these activities may be outlined by the audit team, then be communicated to and agreed upon by the auditee and client before the initial audit.

### Responsibilities of Audits and Client

The auditor, as mentioned, is responsible only for identifying nonconformities. It is the auditee's responsibility to determine and initiate corrective action. Based on the audit findings, particularly the number of systemic problems, or major or vital few nonconformities discovered, it may be necessary to schedule a follow-up audit. This audit may only review nonconformities and corrective actions or may be full-scale. Determining the necessity and extent of a follow-up audit is the decision of the client, which may depend upon a number of factors, which are determined through the course of an audit.

An organization that wants to achieve compliance with a governance standard within a period of 180 days will be taken through of series of distinct yet interlocked steps. These steps include processes to define the organization's need for management systems implementation and compliance, define expectations regarding management systems implementation and compliance, define value-added aspects that could result from management systems implementation and compliance, implement the value-added aspects through management systems implementation and compliance, track the implementation process through appropriate computer software applications, (i.e., databases, project management, schedulers, etc.), track the implementation progress through general manager and consultant manager supervision, create management systems policies and manuals for organizations in a central location, and review management systems procedure manuals in a central location.

Referring now to FIG. 1, a preferred aspect of the present invention is illustrated. Process 10, as generally shown by numeral 10, is implemented for a client organization in block, 12 seeking review of compliance with corporate governance standards. The process is designed for implementation, operation and maintenance of control of governance standards by either an auditor, consultant or the business entity itself.

Process 10 includes a review of client organization using one or more of the following steps: review of the client control environment, as represented in block 14; evaluating risk assessment and paths for action, as represented in block 16; review of client control activities, as represented in block 18; determining the reliability of the financial reporting process, as represented in block 20; evaluating the steps taken to safeguard corporate assets, as represented in block 22; review of procedures and processes relating to information technology, as represented in block 24; monitoring of client practices, as represented in block 26; evaluation of information and communication processes, as represented in block 28; determining the client's compliance with appropriate legal standards, as represented in block 30; and evaluating the efficiency and effectiveness of the client's business practices and procedures, as represented in block 32.

Evaluation of a client's compliance with corporate governance standards may result in one or more deliverables to be presented, reviewed and implemented with the client. The process 10 may include one or more of the following deliverables: standardization of business and governance processes, as represented in block 34; development and improvement in overall business operations, as represented in block 36; implementation of an internal audit of one or more client business practices, as represented in block 38; training the client employees and assets to implement the findings of the process, as represented in block 40; development of internal control criteria for present and future business practices, as represented in block 42; and preparation and delivery of manuals and procedures that document the findings of the process, as represented in block 44. Preferably, at least one or more of these steps are tracked and completed with scheduling and project management software. These steps are discussed in greater detail in the following sections,

### Methodology for Identifying Identify Client Need

The client need is identified through three main channels—the sales representative, the project coordinator and the consultant. The sales representative is introduced to a prospective client through several means, including a referral, the Internet, and/or appointments set in a defined geographic region. After the introduction, the sales representative determines the client's needs through brief interviews with key management.

Once the sales representative has signed a contract with the client, the project coordinator makes his/her initial contact. If client needs differ from the sales representative's findings, it is recorded, and the revisions are documented. The consultant next contacts the client. During the initial site visit, the consultant again will interview key managers to confirm needs initially defined by the sales representative and confirmed and/or refined by the project coordinator. Through these methods, the client need is defined and a process is developed.

Evaluation, registration, accreditation, qualification or conformance to such international and national management systems standards offered to the client is generally illustrated in FIGS. 1 and 3. These standards, such as ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001 for use in marketing of the business, or as a result of customer pressure, are consulting tools generally referenced by numeral 46.

Due to the promulgation of quality, environmental, occupational health and safety, and other management systems standards, there is increased pressure for subcontractors and vendors to become registered, accredited, qualified or in conformance to such international and national management systems standards as ISO 9001:2000, ISO 9001/9002:1994, QS-9000, ISO/TS 16949, VDA 6.1, TL 9000, ISO 13485, the Tooling and Equipment (TE) Supplement, the Semiconductor Supplement, ISO 14001, AS9100, ISO/IEC 17025 and OHSAS 18001. For example, if Customer A requires Vendor B to become registered, accredited, qualified or in conformance to an international or national management systems standard, then. Vendor B may require Subcontractor C to become registered, accredited, qualified or in conformance to the same standard as well. In this vein, an international or national management systems standard may be pall of requirements supply chain members issue to their vendors. A company may feel customer pressure to become registered, accredited, qualified or in conformance to an international or national management systems standard without actually seeing a defined benefit, except satisfying the customer.

In addition, there may be some perceived marketing benefit arising from registration, accreditation, qualification or conformance to international or national management systems standards. The basic idea is that a company may be able to market its goods and services more effectively by having international or national management systems standards registration, accreditation, qualification or conformance. In addition to the above potential client needs, a company seeking registration, accreditation, qualification or conformance to an international or national management systems standard may have other value-added aspects identified. These are dependent on the company and may vary widely from organization to organization.

One example of value-adding is correcting. Some problem or series of problems within the organization through management systems standard implementation. They may encompass any aspect of the business and include scrap rate reduction, rework, increased customer satisfaction and continual improvement.

Another example of value-adding is achieving consistency in certain operations within the organization. Many times, management systems standard. Implementation may be used to bring consistency to an organization which does not yet exist or requires improvement. A third example involves using management systems standard implementation as a discussion tool, which provides a framework for group thinking, brainstorming, and team activities to create innovative solutions to common problems.

A fourth example includes a reduction in liability exposure due to the documentation of good business practices. Another example of value-adding includes seeking reduction in general, specific and product liability insurance premiums as a result of effective management systems standard implementation. Yet another example includes viewing the internal and external costs associated with management systems standard implementation as direct investments in the business, and calculating an acceptable return-on-investment as a result.

### Methodology for Evaluation of Existing Governance Standards

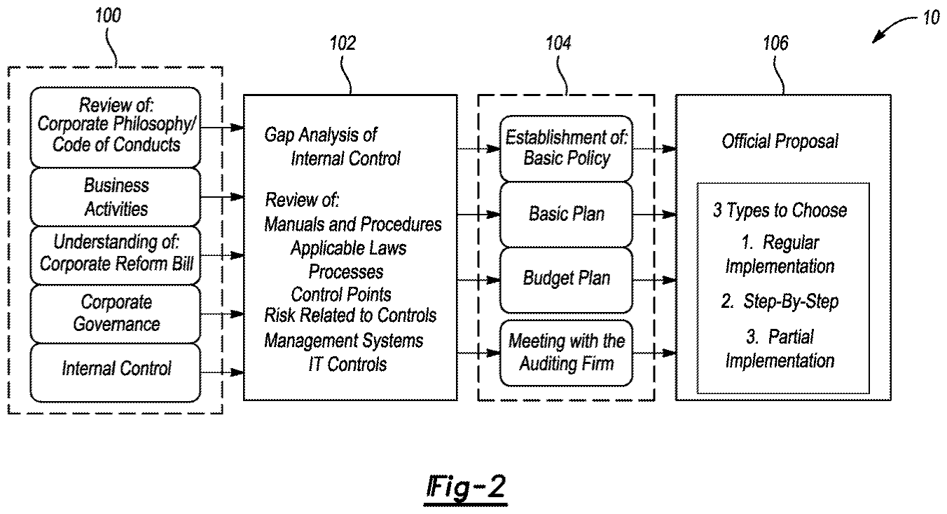

Referring now to FIG. 2, the process 10 for evaluating the governance standards of a client or business entity includes one or more of the following procedures. The process described in accordance with the present invention may be requested by a client who seek compliance with industrial or governance standards, such as the Sarbanes-Oxley Section 404 Management Assessment of Internal Controls for Financial Reporting requirements of the Securities and Exchange Commission and the Public Company Accounting Oversight Board. This process assists the client in establishment of an internal control system that meets such requirements and in the generation of reliable financial, reports.

Block referenced by numeral 100 generally references an orientation process of the client's business operation conducted by an auditor with the client. The orientation process may include a variety of activities, including, but not limited to, a review of the corporate philosophy or code of conduct related to the operation of the business and an analysis of all business activities. Such business activities may include the evaluation of the sales, marketing, information technology, accounting and management relations operations of the client. This process may also include evaluation of internal audit management practices and implementation of these practices in view of the applied process of the present invention.

An evaluation and comprehension of the application of industrial and governance standards, such as the Sarbanes-Oxley Act particulars, including any corporate reform issues is considered by the auditor in the client business review, along with an evaluation of current corporate governance policies and procedures. The auditor may then determine the internal control activity and structure of the client for preparation of a gap analysis.

Block 102 represents the gap analysis and evaluation component of the process 10. The gap analysis leverages the quality management system expertise and process described above to evaluate the internal control structure and procedures of the client. The consultant or auditor reviews the client's internal management systems and controls to determine risk control practices. Various business operations controls, including, but not limited to, information technology controls, applicable laws, processes, control points, risks related to the business controls and other processes to based on the client's business practices are evaluated in view of the financial statements and reporting conducted in association with the business.

Block 104 represents a deliverable component of the process 10 that leverages the findings from the gap analysis conducted in block 102 based on client specific business practices. This evaluation step may include a number of processes to accomplish the objective. It is understood that one or more of these processes may be conducted together to provide the deliverable component. A governance standards policy may be created for each group of the client business entity.

Development and distribution of the plan to the client occurs upon completion of the gap analysis and industrial or governmental standards. Budget resources may be allocated by the client to implement any process or procedure changes required by the governance standards policy. Further, presentation and review of the governance standards policy with the client to gather the input of the client's business contacts is conducted to supplement the deliverable component.

Block 106 represents presentation of the governance standards policy to the client for review and decision. The policy may be enacted in a variety of steps and may be either implemented in portions or in full. Preferably, at least one or more of these steps are tracked and completed with scheduling and project management software. The governance standards policy delivered to the client focuses on the assessment and proposed responses to potential errors in present and future financial statements based on risks and practices inherent to the client's business practices.

In one aspect of the present invention, the method is implemented by providing training to the client organization to develop awareness of the industrial or governance standard and the client's need for compliance. The auditor may determine significant accounts and sites related to the client's consolidated financial statement and implement a risk assessment policy for the client's business operations based on the deliverable component.

The auditor may assess client risk and create internal audit procedure based on the deliverable component to implement corrective actions for client internal controls. The audit procedure may cover issues such as governance, compliance and information technology (IT) control. Training to educate employees of the client as to the industrial or governance standards, details of the deliverable component action plan, identification and assessment of risks and implementation of internal controls may also be provided.

The auditor may next establish an internal control management system in accordance with, the present invention with the client. The process further contemplates that the auditor revisit the client to update the deliverable component to assist with implementation thereof. Further, monitoring the client business practices to ensure compliance with the deliverable component and industrial or governmental standards is also contemplated.

### Methodology for On-Site Consultant Visit

In addition to the further refinement of the client or business entity need as described above, the consultant during the initial visit accomplishes the following tasks: collects information for preparation of the management systems manual; interviews key managers and employees; collects sufficient information for the preparation of the first draft of the management systems procedures; determines the scope of registration, accreditation, qualification or conformance; approximates the time when the preassessment, Stage 1, registration, accreditation, qualification, conformance or Stage 2 audits could occur. In addition, if the preassessment or Stage 1 audit must be precisely defined, the consultant would work with the selected management systems registrar or accreditation body to schedule it; and performs an initial on-site visit as close as possible to the preassessment, Stage 1, registration, accreditation, qualification, conformance or Stage 2 audit. The consultant visit should have an agenda similar to an audit plan; an opening meeting; a closing meeting; and an action plan for management systems standard implementation that would be similar to a corrective action plan.

### Methodology for Writing of Policy, Procedures and Manual

As a result of the initial visit, the consultant gathers the necessary information to write the management systems procedures. The contents of the quality procedures are based on the applicable element of the management systems standard, specifically that the procedures address or are consistent with the requirements of the standard.

In addition, for any unique business, applying the management systems standard can be difficult. To use the applicable standard with unique applications may require cognitive reasoning, abstract thinking, and basic process models to businesses. In light of these factors, writing procedures requires a great deal of insight on behalf of the consultant. Good communication skills also are important, because they enable him/her to discern necessary information from the company.

### Methodology for Review Through Client Consultation, Etc.

Once drafts of documents are written, they are sent to a central source. These employees are responsible for reviewing manuals and other documents to ensure they conform to all requirements of the applicable management systems standard. Experienced and highly trained consultants review the documents. If all requirements are not met, the manuals are considered nonconforming to the standard. They are returned to the consultant. The consultant makes any changes necessary to bring the manuals into conformance. Once manuals conform, they are processed and forwarded to the client for review.

### Methodology for Revisit to the Client Site

Providing motivation and leadership to the client is a pivotal factor in becoming successfully registered, accredited, qualified or in conformance. To this end, the consultant's definition of the registration, accreditation, qualification or conformance process is imperative. Many times the company may be provided with draft copies of the management systems policy, manual and procedures. However, reviewing them may take some time. This delay is due to other time-consuming commitments, lack of interest and other excuses.

In order to avoid these problems, the general manager and schedulers set up a time for the consultant to return to the site, directly review documents with the client, and make any necessary changes. This provides the definition that the company requires, and forces document review and revision.

In addition to document review and changes, the consultant begins implementing the applicable management system. Ultimately, it is the company's responsibility to effectively implement the applicable management system. This is reflected in the applicable element of the management systems standard. The consultant, however, initially leads this effort and demonstrates the most effective implementation techniques.

### Methodology for Assisting in Scheduling Pre-Assessment and Registration Audit

The consultant assists in scheduling preassessment, Stage 1, registration, accreditation, qualification, conformance or Stage 2 audits with the management systems registrar or accreditation body.

In addition to document and implementation guidance, the consultant also acts as a liaison with the management system registrar or accreditation body to schedule the preassessment, Stage 1, registration, accreditation, qualification, conformance or Stage 2 audits. In this role, the consultant ensures that audits are scheduled and conducted on a timely basis, and registration, accreditation, qualification or conformance is achieved within 180 days.

### Methodology for Making Connections

The consultant makes any necessary document corrections after the preassessment, Stage 1, registration, accreditation, qualification, conformance or Stage 2 audits to ensure conformance to the applicable management systems standard and the registrar's or accreditation body's requirements.

Once the preassessment, Stage 1, registration, accreditation, qualification, conformance or Stage 2 audits occur, changes in documentation are invariably required. Documentation is a living portion of the applicable management system, and it will always need adjustment after all audits, including surveillance audits.

Since the consultant initially wrote the documentation and usually has a higher level of training regarding the applicable management systems standard, he/she also is responsible for making changes. The consultant is better equipped, especially from the standpoint of experience. Any audit might uncover a nonconformity that requires a creative solution. The consultant's extensive knowledge and experience can provide these solutions, when documentation changes must be made.

### Methodology for Tracking Project Status

All project stages are tracked through the use of scheduling and project management software. Project managers monitor the client status and also ensure that consultants are meeting identified client needs in the allotted time frame.

Because assignments are time sensitive, it is important for the consultant to lead and manage the client. The corollary to this is that the consultant also needs to be managed, and organizational leadership provided. This is done through consultant coordinators, project managers and project management software. The base software is Paradox, configured to meet specific requirements for reporting and monitoring.

The use of consultant coordinators and project managers, as well as software, enables effective supervision of consultants and projects. Most importantly, current or potential problems can be quickly identified, and appropriate corrective and preventive actions may be taken.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for evaluating and achieving compliance with industrial or governmental standards, the method comprising:
obtaining client information to identify a client's business operations procedures and a client's needs;
reviewing applicable industrial or governmental standard particulars;
evaluating the client's business operations in view of industrial or governmental standard particulars;
presenting a deliverable component to the client identifying revisions to client business practices to conform to the industrial or governmental standards; and
implementing a risk assessment policy for the client based on the findings of the deliverable component.

2. The method of claim 1 wherein the method is tracked with scheduling and project management software.

3. The method of claim 1 wherein the method is completed within about 10 months to about 18 months.

4. The method of claim 1 wherein the industrial standard evaluated is the Sarbanes-Oxley Act Section 404 Management Assessment of Internal Controls for Financial Reporting requirements of the Securities and Exchange Commission and the Public Company Accounting Oversight Board.

5. The method of claim 1 wherein the step of evaluating the client's needs includes the steps of:
reviewing corporate philosophy relating to the operation of the business;
analyzing business activities associated with operation of the client;
evaluating current corporate governance policies and procedures; and
determining the internal control activity and structure of the client

6. The method of claim 5 wherein the step of analyzing business activities further includes a review of the sales, marketing, information technology, accounting and management relations operations of the client.

7. The method of claim 1 further comprising the step of evaluating internal audit management practices for use in implementation of the internal management controls.

8. The method of claim 1 wherein the step of presenting a deliverable component further comprises the steps of:
reviewing the findings from the evaluation of the client's business operations in view of industrial or governmental standard particulars;
creating a governance standards policy for each group of the client business entity;
presenting the governance standards policy with the client.

9. The method of claim 8 further comprising the step of presenting and reviewing the governance standards policy with the client to gather the input of the client's business contacts is conducted to supplement the deliverable component.

10. The method of claim 1 further comprising the step of revisiting the client to update the deliverable component to assist with implementation thereof.

11. The method of claim 1 limber comprising the step of monitoring the client business practices to ensure compliance with the deliverable component and industrial or governmental standards.

12. The method of claim 1 further comprising the step of establishing an internal control management system for the client based on the findings presented in the deliverable component.

13. The method of claim 1 further comprising the step of providing risk management training to the client based on the findings of the deliverable component.

14. The method of claim 13 wherein the training is directed to the industrial or governance standards.
